(19) United States
(12) Patent Application Publication
(10) Pub. No.: US 2023/0254270 A1
(43) Pub. Date: Aug. 10, 2023

(54) COMPUTER-READABLE RECORDING MEDIUM STORING PROGRAM, INFORMATION PROCESSING METHOD, AND INFORMATION PROCESSING SYSTEM

(71) Applicant: Fujitsu Limited, Kawasaki-shi (JP)

(72) Inventors: Daiki YAMAKOSHI, Kawasaki (JP); Masato ITO, Kawasaki (JP); Atsushi KUWABAYASHI, Hachioki (JP); Yu KAWAGITA, Kawasaki (JP); Tsutomu KANEKO, Yokohama (JP)

(73) Assignee: Fujitsu Limited, Kawasaki-shi (JP)

(21) Appl. No.: 18/060,597

(22) Filed: Dec. 1, 2022

(30) Foreign Application Priority Data
Feb. 7, 2022 (JP) 2022-017106

(51) Int. Cl. H04L 49/55; G06F 11/20; H04L 41/0668

(52) U.S. Cl. CPC H04L 49/557; G06F 11/2097; H04L 41/0668

(57) ABSTRACT

A non-transitory computer-readable recording medium stores a program for causing a computer that operates as an operation node in an information processing system which includes the operation node, a standby node corresponding to the operation node, and a network node which relays communication from a client node to the operation node or the standby node, to execute a process including: acquiring first information that is an output of a serverless function executed by the information processing system and indicates a result of coupling checking by the serverless function for a first service used for monitoring of the network node by the operation node; and controlling whether or not to switch a node of an access destination by the client node via the network node from the operation node to the standby node, based on the first information.

### CROSS-REFERENCE TO RELATED APPLICATION

This application is based upon and claims the benefit of priority of the prior Japanese Patent Application No. 2022-17106, filed on Feb. 7, 2022, the entire contents of which are incorporated herein by reference.

### FIELD

The embodiments discussed herein are related to a non-transitory computer-readable recording medium storing a program, an information processing method, and an information processing system.

### BACKGROUND

In recent years, instead of a user possessing in person an information processing environment for executing an application program, the user increasingly uses an information processing environment owned by a service provider via a network. An information processing system that uses the information processing environment via the network may be referred to as a cloud system. The cloud system lends a unit calculation resource such as a physical machine or a virtual machine to the user, and executes the application program created by the user on the unit calculation resource. A processing entity implemented by the physical machine or the virtual machine may be referred to as a node.

Japanese Laid-open Patent Publication No. 2019-46015 and Japanese Laid-open Patent Publication No. 2019-197352 are disclosed as related art.

### SUMMARY

According to an aspect of the embodiments, a non-transitory computer-readable recording medium stores a program for causing a computer that operates as an operation node in an information processing system which includes the operation node, a standby node corresponding to the operation node, and a network node which relays communication from a client node to the operation node or the standby node, to execute a process including: acquiring first information that is an output of a serverless function executed by the information processing system and indicates a result of coupling checking by the serverless function for a first service used for monitoring of the network node by the operation node; and controlling whether or not to switch a node of an access destination by the client node via the network node from the operation node to the standby node, based on the first information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an information processing system according to a first embodiment;

FIG. 2 is a diagram illustrating an example of an information processing system according to a second embodiment;

FIG. 3 is a diagram illustrating a hardware example of a physical machine;

FIG. 4 is a diagram illustrating a network example of the information processing system;

FIG. 5 is a diagram illustrating a function example of the information processing system;

FIG. 6 is a diagram illustrating an example of a heartbeat of an operation node and a standby node;

FIG. 7 is a diagram illustrating an example of monitoring setting data;

FIG. 8 is a diagram illustrating a generation example of an API monitoring result by an API coupling monitoring unit;

FIG. 9 is a diagram illustrating a generation example of a network (NW) monitoring result by an NW monitoring unit;

FIG. 10 is a flowchart illustrating a processing example of a monitoring setting unit;

FIG. 11 is a flowchart illustrating an example of API coupling monitoring by a serverless function;

FIG. 12 is a flowchart illustrating an example of NW monitoring by the serverless function;

FIG. 13 is a flowchart illustrating a processing example of a cluster control unit;

FIG. 14 is a flowchart illustrating a processing example of a monitoring result processing unit;

FIG. 15 is a flowchart illustrating a processing example of an NW setting unit;

FIG. 16 is a flowchart illustrating an example of switching control by the cluster control unit; and

FIG. 17 is a flowchart illustrating a processing example of the cluster control unit of a standby node.

### DESCRIPTION OF EMBODIMENTS

For example, the cloud system executes various services available in the application program of the user. The application program of the user uses a service by calling an application programming interface (API) provided by the service. For example, the cloud system may provide a service called an API gateway that supports calling of an API of a backend service by the application program. The API gateway makes it possible to call the API of the backend service by designating an identifier called an API end point in the application program. The cloud system may deploy a lightweight program called a serverless function created by the user, and execute the serverless function for a short time when a specific event occurs.

A method for monitoring an operation of the application program running on the cloud system is proposed. For example, there is a proposal for an application operation monitoring apparatus that transmits a pseudo request to an API of a service used from an application program and determines whether the API of the service is operating normally.

A service continuation system having a highly available cluster configuration including an active system virtual server and a standby system virtual server is also proposed. The standby system virtual server mutually transmits a heartbeat to the active system virtual server, and provides a service on behalf of the active system virtual server in a case where the heartbeat is stopped.

As described above, an operation node and a standby node may be provided in an information processing system such as a cloud system. The operation node may be switched to an operation by the standby node in response to detection of an abnormality.

The operation node monitors a predetermined network node such as a router, used for control for switching an access destination of a client from the operation node to the standby node, and in a case where the abnormality is detected in the monitoring, the operation node may be switched to the standby node. The operation node may access information of the network node via an API of a service for monitoring the network node, which is provided by the information processing system. Therefore, the operation node periodically executes the API to establish coupling from the operation node to the service, and monitors the network node.

The operation node may execute an API via an API end point provided by a predetermined node that functions as an API gateway in the information processing system. Accordingly, in a case where a coupling property of a network between the operation node and the API end point is not ensured, the operation node fails to execute the API. In this case, the operation node may detect an abnormality in monitoring of the network node, and switch to an operation by the standby node.

A network between the operation node and a node that provides the API end point is managed by the information processing system so as to operate appropriately. Accordingly, even when an event occurs in which the coupling property of the network is temporarily not ensured, there is a high possibility that the event is restored by the information processing system in a relatively short time. For example, in a case where detection of an abnormality by the operation node is caused by the coupling property of the network between the operation node and the API end point, there is a possibility that the operation node performs undesirable switching to the standby node although a necessity of switching to the standby node is low.

In one aspect, an object of the present disclosure is to suppress undesirable switching.

Hereinafter, the present embodiments will be described with reference to the drawings.

### First Embodiment

A first embodiment will be described.

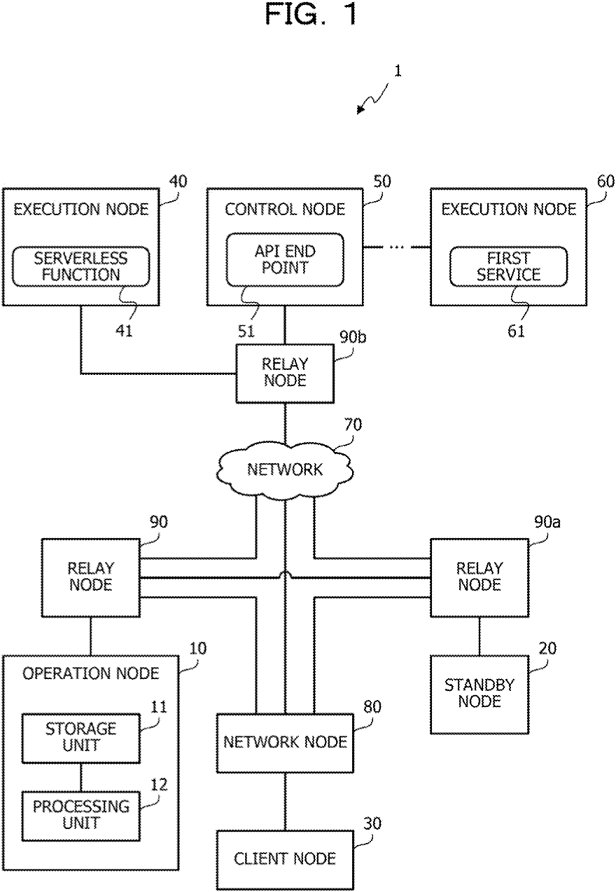

FIG. 1 is a diagram describing an information processing system according to the first embodiment.

An information processing system 1 includes a plurality of physical machines that are physical computers or a plurality of network devices, and enables a user to use resources of the physical machines or the network devices via a network. The information processing system 1 may be, for example, a cloud system that provides a cloud service.

The information processing system 1 includes an operation node 10, a standby node 20, a client node 30, execution nodes 40 and 60, a control node 50, a network 70, a network node 80, and relay nodes 90, 90a, and 90b. The information processing systems 1 may not include the client node 30. For example, the client node 30 may be located outside the information processing system 1. Each of the operation node 10, the standby node 20, the client node 30, the execution nodes 40 and 60, the control node 50, the network node 80, and the relay nodes 90, 90a, and 90b may be implemented by a physical computer, for example, a physical machine, or may be implemented by a virtual machine operating on the physical machine.

The client node 30 is coupled to the network node 80. The operation node 10 is coupled to the relay node 90. The standby node 20 is coupled to the relay node 90a. The execution node 40 and the control node 50 are coupled to the relay node 90b. The network node 80 and the relay nodes 90, 90a, and 90b are coupled to the network 70. The network node 80 and the relay nodes 90, 90a, and 90b may be virtual private cloud (VPC) routers. The network 70 is an internal network of the information processing system 1. The network 70 is formed with a plurality of relay nodes (not illustrated). The relay node 90b belongs to a network at a higher level than the relay nodes 90 and 90a. The control node 50 is coupled to the execution node 60 via a network (not illustrated) inside the information processing system 1.

The operation node 10 includes a storage unit 11 and a processing unit 12, for example. The storage unit 11 may be implemented by a volatile storage device such as a random-access memory (RAM), and may be implemented by a non-volatile storage device such as a hard disk drive (HDD) or a flash memory. The processing unit 12 may include a central processing unit (CPU), a digital signal processor (DSP), an application-specific integrated circuit (ASIC), a field-programmable gate array (FPGA), or the like. The processing unit 12 may be a processor that executes a program. The “processor” may include a set of a plurality of processors (multiprocessor).

The standby node 20, the client node 30, the execution nodes 40 and 60, the control node 50, the network node 80, and the relay nodes 90, 90a, and 90b are also implemented by the same hardware as the hardware of the operation node 10. The network node 80 is used for switching an access destination from the client node 30 to the operation node 10 or the standby node 20. For example, a transfer destination of a request from the client node 30 is switched to the operation node 10 or the standby node 20 by setting routing information held in the network node 80.

The operation node 10 is an active system node that provides a predetermined service to the client node 30. The standby node 20 is a standby system node for the operation node 10. For example, the operation node 10 and the standby node 20 form a cluster system as a subsystem of the information processing system 1. The operation node 10 and the standby node 20 may communicate with each other via the relay nodes 90 and 90a, and transmit a heartbeat to each other. The heartbeat is used for life-and-death monitoring of a partner node by the operation node 10 and the standby node 20.

For example, when the heartbeat from the operation node 10 is stopped, the standby node 20 detects a service provision stop by the operation node 10. The standby node 20 sets the network node 80 such that an access destination from the client node 30 is switched from the operation node 10 to the standby node 20. Accordingly, the standby node 20 provides the service to the client node 30 instead of the operation node 10.

The operation node 10 monitors an access abnormality to information of the network node 80, for example, routing information or the like. In a case of detecting the access abnormality, the operation node 10 determines that an appropriate operation of the operation node 10 may not be performed, and the operation is switched to an operation in the standby node 20. In order to stop the heartbeat of the operation node 10, for example, the operation node 10 may be shut down.

The information processing system 1 provides a first service 61 for monitoring the network node 80. The first service 61 is executed by the execution node 60. By using an API of the first service 61, the operation node 10 or the standby node 20 may acquire information on the network node 80. The information processing system 1 includes an API end point 51 for accessing the first service 61 from the operation node 10. The API end point 51 is a uniform resource identifier (URI) for accessing the API of the first service 61. A correspondence relationship between the API end point 51 and the first service 61 is managed by the control node 50. For example, the control node 50 functions as an API gateway for accessing the backend first service 61 from the operation node 10.

The network 70 or the relay node 90b is interposed between the operation node 10 and the control node 50. Therefore, a problem in the network 70 affects a coupling property from the operation node 10 to the first service 61. An example of the problem in the network 70 is a case where communication in the network 70 is temporarily delayed due to a temporary increase in load.

For example, when there is a problem due to the network 70 in communication from the operation node 10 to the control node 50, the operation node 10 may not correctly acquire information on the network node 80 and may detect an abnormality in monitoring of the network node 80.

On the other hand, the network 70 is managed by the information processing system 1 so as to maintain a normal operation. For example, the temporary increase in load on the network 70 may be quickly dealt with by scale-out of network resources by the information processing system 1, or may be naturally restored by a decrease in load. In this manner, in a case where the access abnormality from the operation node 10 to the information of the network node 80 is caused by a problem of the network 70, it is highly likely that the problem of the network 70 is restored in a short time, and it is highly likely that the access abnormality is also restored in a relatively short time. Accordingly, in a case where the operation node 10 fails to execute the API of the first service 61 and detects an access abnormality, the operation node 10 provides a function of determining whether or not the access abnormality is caused by the network 70.

For example, the processing unit 12 causes the information processing system 1 to execute a serverless function 41. The serverless function 41 is a lightweight program for checking coupling to the first service 61. For example, the serverless function 41 is periodically executed by the execution node 40. The serverless function 41 issues a predetermined command for checking coupling to the API end point 51, and checks coupling to the first service 61 via the API end point 51 based on an execution result of the command. The serverless function 41 stores first information indicating a result of the coupling checking in the storage unit 11 of the operation node 10 or a predetermined storage unit accessible from the operation node 10. The first information includes information indicating whether or not the serverless function 41 is successfully coupled to the first service 61 via the API end point 51.

For example, in a case where an access abnormality to the information of the network node 80 is detected by monitoring by the operation node 10, the processing unit 12 determines whether or not the access abnormality is caused by the network 70 between the operation node 10 and the API end point 51 based on the first information.

The serverless function 41 is executed by the execution node 40. The execution node 40 belongs to a network at a higher level than the operation node 10. Accordingly, the serverless function 41 is unlikely to be affected by the network 70 when checking coupling to the first service 61.

In a case where a monitoring result of the serverless function 41 is normal, the processing unit 12 determines that an access abnormality detected by the processing unit 12 is due to a coupling property between the operation node 10 and the API end point 51 via the network 70, and does not perform switching to the standby node 20. This is because there is a high possibility that the problem of the coupling property caused by the network 70 is restored in a relatively short time as described above. By contrast, in a case where the monitoring result of the serverless function 41 is abnormal, the processing unit 12 determines that the access abnormality detected by the processing unit 12 has another factor and is unlikely to be restored in a short time, and performs switching to the standby node 20.

In this manner, with the information processing system 1, the execution node 40 executes the serverless function 41 to acquire the first information indicating the result of checking coupling to the first service 61, and the first information is stored in the storage unit 11 accessible from the operation node 10. Based on the first information stored in the storage unit 11, the operation node 10 controls whether or not to switch a node of an access destination by the client node 30 via the network node 80 from the operation node 10 to the standby node 20.

Therefore, the operation node 10 may suppress undesirable switching to the standby node 20. For example, since the serverless function 41 is executed in a network at a higher level than the operation node 10, the serverless function 41 is unlikely to be affected by the network 70 when coupling to the first service 61 is checked. Therefore, by using the first information output by the serverless function 41, the operation node 10 may appropriately determine whether or not an access abnormality to the information of the network node 80 detected by the operation node 10 is caused by the network 70, for example. The operation node 10 may appropriately specify an event in which switching to the standby node 20 is to be performed, and suppress undesirable switching.

Hereinafter, a more specific example described below, and the functions of the information processing system 1 will be described in more detail.

### Second Embodiment

Next, a second embodiment will be described.

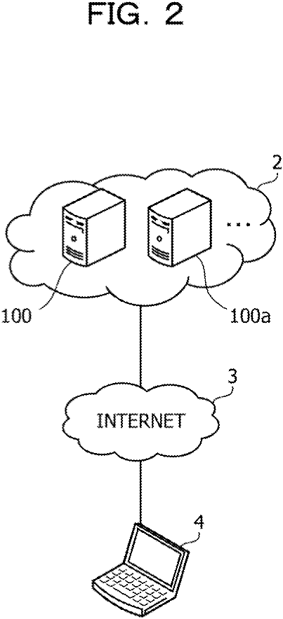

FIG. 2 illustrates an example of an information processing system according to the second embodiment.

An information processing system 2 provides a cloud service. The information processing system 2 may be referred to as a cloud system. Amazon Web Services (AWS) is an example of the cloud service. AWS is a registered trademark. Amazon is a registered trademark. Meanwhile, the information processing system 2 may provide another cloud service. The information processing system 2 includes physical machines 100, 100a, .... The physical machines 100, 100a, ... are servers having an operation resource provided to a user. Although not illustrated, the information processing system 2 further includes a large number of hardware such as network devices or storage devices. The information processing system 2 lends resources such as the physical machines 100, 100a, ..., the network devices, and the storage devices to the user, and enables the user to use the resources.

The information processing system 2 is coupled to an Internet 3. A terminal apparatus 4 is coupled to the Internet 3. The terminal apparatus 4 is a client computer operated by the user. The user may use a service of the information processing system 2 by operating the terminal apparatus 4.

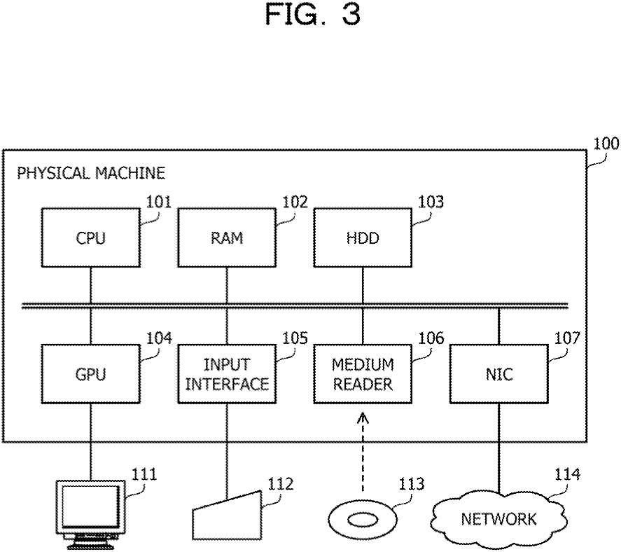

FIG. 3 is a diagram illustrating a hardware example of a physical machine.

A physical machine 100 includes a CPU 101, a RAM 102, an HDD 103, a graphics processing unit (GPU) 104, an input interface 105, a medium reader 106, and a network interface card (NIC) 107. The CPU 101 is an example of the processing unit 12 according to the first embodiment. The RAM 102 or the HDD 103 is an example of the storage unit 11 according to the first embodiment.

The CPU 101 is a processor that executes a command of a program. The CPU 101 loads at least a part of a program or data stored in the HDD 103 into the RAM 102, and executes the program. The CPU 101 may include a plurality of processor cores. The physical machine 100 may include a plurality of processors. Processing to be described below may be executed in parallel by using the plurality of processors or processor cores. A set of the plurality of processors may be referred to as a “multiprocessor” or simply referred to as a “processor”.

The RAM 102 is a volatile semiconductor memory that temporarily stores the program executed by the CPU 101 or data used for an operation by the CPU 101. The physical machine 100 may include a type of memory different from the RAM, or include a plurality of memories.

The HDD 103 is a non-volatile storage device that stores data as well as programs of software such as an operating system (OS), middleware, or application software. The physical machine 100 may include another type of storage device such as a flash memory or a solid-state drive (SSD), and may include a plurality of non-volatile storage devices.

According to a command from the GPU 104, the CPU 101 outputs an image to the display 111 coupled to the physical machine 100. As the display 111, arbitrary type of display such as a cathode ray tube (CRT) display, a liquid crystal display (LCD), a plasma display, or an organic electro-luminescence (OEL) display may be used.

The input interface 105 acquires an input signal from the input device 112 coupled to the physical machine 100, and outputs the input signal to the CPU 101. As the input device 112, a pointing device such as a mouse, a touch panel, a touchpad, or a trackball, a keyboard, a remote controller, a button switch, or the like may be used. A plurality of types of input devices may be coupled to the physical machine 100.

The medium reader 106 is a reading device that reads a program or data recorded in a recording medium 113. As the recording medium 113, for example, a magnetic disk, an optical disk, a magneto-optical (MO) disk, a semiconductor memory, or the like may be used. The magnetic disk includes a flexible disk (FD) or an HDD. The optical disk includes a compact disc (CD) or a Digital Versatile Disc (DVD).

The medium reader 106 copies, for example, the program or data read from the recording medium 113 to another recording medium such as the RAM 102 or the HDD 103. The read program is executed by, for example, the CPU 101. The recording medium 113 may be a portable-type recording medium, or may be used to distribute the program or data. The recording medium 113 or the HDD 103 may be referred to as a computer-readable recording medium.

The NIC 107 is an interface that is coupled to the network 114, and communicates with another computer via the network 114. The NIC 107 is coupled to, for example, a communication device such as a switch or a router through a cable. The NIC 107 may be a wireless communication network. A network 114 is an internal network of the information processing system 2.

Other physical machines in the information processing system 2 including the physical machine 100a or the terminal apparatus 4 are also implemented by the same hardware as the hardware of the physical machine 100.

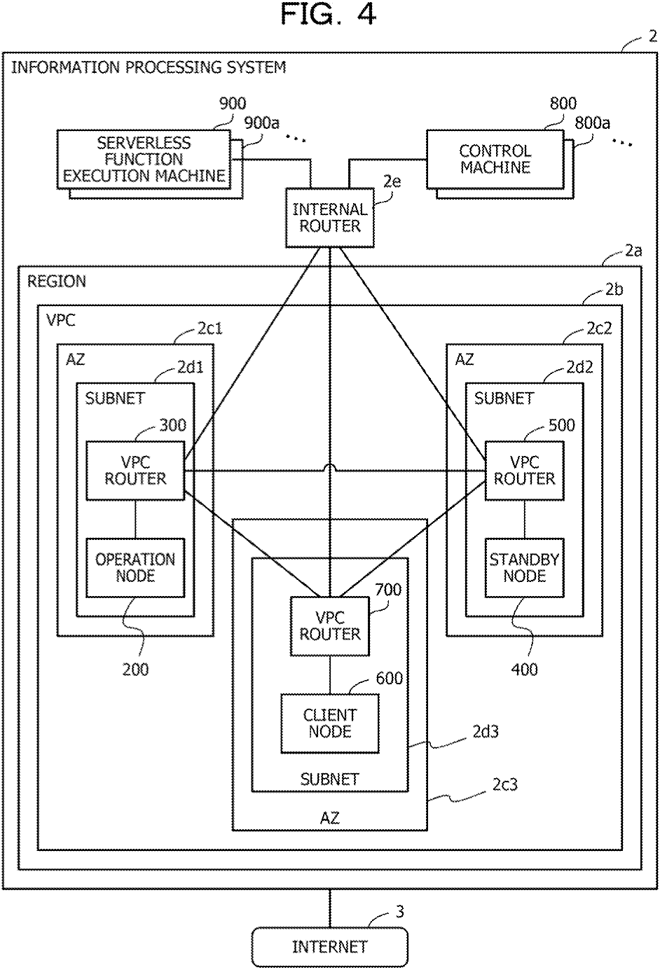

FIG. 4 is a diagram illustrating a network example of the information processing system.

The information processing system 2 includes a region 2a, a VPC 2b, availability zones (AZs) 2c1, 2c2, and 2c3 and subnets 2d1, 2d2, and 2d3.

The region 2a is a management unit of a network corresponding to a certain area. The VPC 2b is a management unit of a network allocated to a user inside the region 2a. The AZs 2c1, 2c2, and 2c3 are management units of a network corresponding to a data center located inside the region 2a. Each of the subnets 2d1, 2d2, and 2d3 is a management unit of a network allocated to the user inside the AZs 2c1, 2c2, and 2c3. Among the region 2a, the AZs 2c1, 2c2, and 2c3, and the subnets 2d1, 2d2, and 2d3, the region 2a is a management unit of the highest hierarchical level, and the subnets 2d1, 2d2, and 2d3 are management units of the lowest hierarchical level.

The subnet 2d1 includes an operation node 200 and a VPC router 300. The subnet 2d2 includes a standby node 400 and a VPC router 500. The subnet 2d3 includes a client node 600 and a VPC router 700. The VPC router is an example of a network node and a relay node according to the first embodiment. The VPC router 700 may also be referred to as a network component.

The operation node 200 is coupled to the VPC router 300. The standby node 400 is coupled to the VPC router 500. The client node 600 is coupled to the VPC router 700. The VPC router 300 is coupled to the VPC routers 500 and 700. The VPC router 500 is coupled to the VPC router 700. Each of the VPC routers 300, 500, and 700 is coupled to an internal router 2e of the information processing system 2 via an internal network (not illustrated) in the information processing system 2. The internal router 2e belongs to a network in a higher hierarchical level than the region 2a. The VPC routers 300, 500, and 700 relay communication between the operation node 200, the standby node 400, and the client node 600. The VPC routers 300, 500, and 700 respectively relay communication of the operation node 200, the standby node 400, and the client node 600 with the internal router 2e.

The operation node 200 is an active system node that provides a predetermined service to the client node 600. The standby node 400 is a standby system node for the operation node 200. The operation node 200 and the standby node 400 form a cluster system as a subsystem of the information processing system 2. The VPC router 700 is used for switching whether an access destination of a client node 600 is the operation node 200 or the standby node 400. For example, in a case where the access destination of the client node 600 is the operation node 200, a route table for transferring a request from the client node 600 to the VPC router 700 is set in the VPC router 300. The route table is an example of routing information to be used to select a data transfer destination by the VPC router 700. In a case where the access destination of the client node 600 is the standby node 400, a route table for transferring a request from the client node 600 to the VPC router 500 is set in the VPC router 700.

The client node 600 is a node used by the user. For example, the user uses the terminal apparatus 4 to operate the client node 600 via the Internet 3. The user may use the terminal apparatus 4 to perform a setting on the operation node 200 or the standby node 400 via the Internet 3.

The information processing system 2 further includes control machines 800, 800a, ... and serverless function execution machines 900, 900a, .... The control machines 800, 800a, ... are machines to be used for executing an API gateway that provides an API end point or a service corresponding to the API end point. The control machines 800, 800a, ... are coupled to the internal router 2e. The serverless function execution machines 900, 900a, ... are machines to be used to execute a serverless function. The serverless function execution machines 900, 900a, ... are coupled to the internal router 2e.

The operation node 200, the standby node 400, the VPC routers 300, 500, and 700, the control machines 800, 800a, ..., the serverless function execution machines 900, 900a, ..., and the internal router 2e are implemented by using hardware of the physical machines 100, 100a, .... For example, the operation node 200, the standby node 400, the VPC routers 300, 500, and 700, the control machines 800, 800a, ..., the serverless function execution machines 900, 900a, ..., and the internal router 2e may be virtual machines implemented by using the hardware of the physical machines 100, 100a, ....

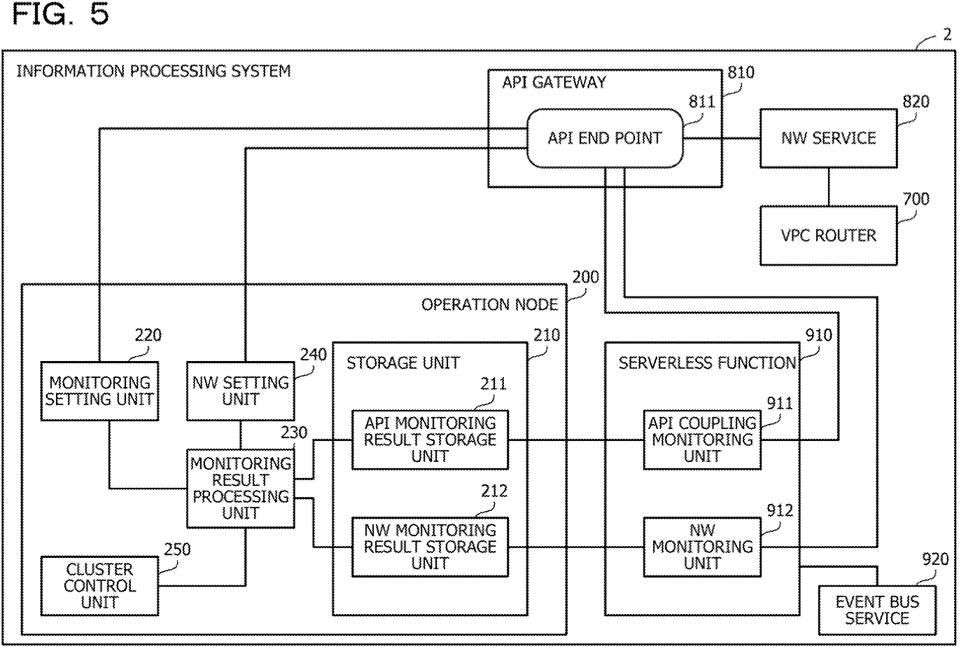

FIG. 5 is a diagram illustrating a function example of the information processing system.

In FIG. 5, nodes other than the operation node 200 and the VPC router 700 among the respective nodes of the information processing system 2 illustrated in FIG. 4 are not illustrated. The information processing system 2 further includes an API gateway 810, a network (NW) service 820, a serverless function 910, and an event bus service 920.

The API gateway 810 and the NW service 820 are implemented by at least one machine of the control machines 800, 800a, .... The serverless function 910 is executed by one machine of the serverless function execution machines 900, 900a, .... The event bus service 920 is implemented by any one machine of the control machines 800, 800a, ... or the serverless function execution machines 900, 900a, ....

The API gateway 810 manages a correspondence relationship of the API end point 811 and the NW service 820. The NW service 820 is a service that acquires a route table of the VPC router 700, and performs a setting of the route table.

The serverless function 910 is a lightweight program that enables or disables coupling to the NW service 820 via the API end point 811, and acquires the route table of the VPC router 700. For example, the serverless function 910 is executed in a container operating on one of the serverless function execution machines. In a case of AWS, the serverless function is referred to as a Lambda function. The serverless function 910 includes an API coupling monitoring unit 911 and an NW monitoring unit 912.

The API coupling monitoring unit 911 monitors a coupling availability to the NW service 820 via the API end point 811, and notifies the operation node 200 of a monitoring result.

The NW monitoring unit 912 acquires a route table of the VPC router 700, and notifies the operation node 200 of an acquisition result.

The API coupling monitoring unit 911 and the NW monitoring unit 912 may be a single serverless function or may be respectively separate serverless functions.

The event bus service 920 is a service that activates the serverless function 910. The event bus service 920 activates the serverless function 910 at a predetermined time interval.

The operation node 200 includes a storage unit 210, a monitoring setting unit 220, a monitoring result processing unit 230, an NW setting unit 240, and a cluster control unit 250. A storage region of the RAM 102 or the HDD 103 allocated to the operation node 200 is used for the storage unit 210. The monitoring setting unit 220, the monitoring result processing unit 230, the NW setting unit 240, and the cluster control unit 250 are implemented by the CPU 101 allocated to the operation node 200 executing a program stored in the RAM 102.

The storage unit 210 includes an API monitoring result storage unit 211 and an NW monitoring result storage unit 212. The API monitoring result storage unit 211 stores a result of checking coupling to the NW service 820 via the API end point 811 by the API coupling monitoring unit 911, for example, an API monitoring result. The NW monitoring result storage unit 212 stores an acquisition result of the route table of the VPC router 700 by the NW monitoring unit 912, for example, an NW monitoring result.

Based on monitoring setting data input by a user, the monitoring setting unit 220 performs a setting of the serverless function 910 or the monitoring result processing unit 230.

According to a request from the cluster control unit 250, the monitoring result processing unit 230 notifies the cluster control unit 250 of whether or not coupling from the serverless function 910 to the NW service 820 is normally performed based on the API monitoring result of the API monitoring result storage unit 211. In a case where the coupling from the serverless function 910 to the NW service 820 is normally performed and the NW monitoring result is not a normal route table, the monitoring result processing unit 230 instructs the NW setting unit 240 to optimize the route table of the VPC router 700. The normal route table is a route table for appropriately routing a request from the client node 600 to the VPC router 300, by the VPC router 700.

According to the instruction from the monitoring result processing unit 230, the NW setting unit 240 updates the route table of the VPC router 700 to a normal route table. By using the NW service 820, the NW setting unit 240 updates the route table of the VPC router 700.

The cluster control unit 250 controls switching to the standby node 400. For example, the cluster control unit 250 checks coupling to the NW service 820 via the API end point 811, and when detecting a coupling abnormality to the NW service 820, the cluster control unit 250 requests the monitoring result processing unit 230 for an API monitoring result by the serverless function 910. In a case where the API monitoring result by the serverless function 910 is normal, the cluster control unit 250 determines not to perform switching into the standby node 400. In a case where the API monitoring result by the serverless function 910 is abnormal, the cluster control unit 250 determines to perform switching into the standby node 400.

The cluster control unit 250 or the serverless function 910 designates the API end point 811, issues a predetermined command for checking of coupling, and performs coupling checking for the NW service 820, based on an execution result of the command.

The operation node 200 and the standby node 400 transmit a heartbeat to each other.

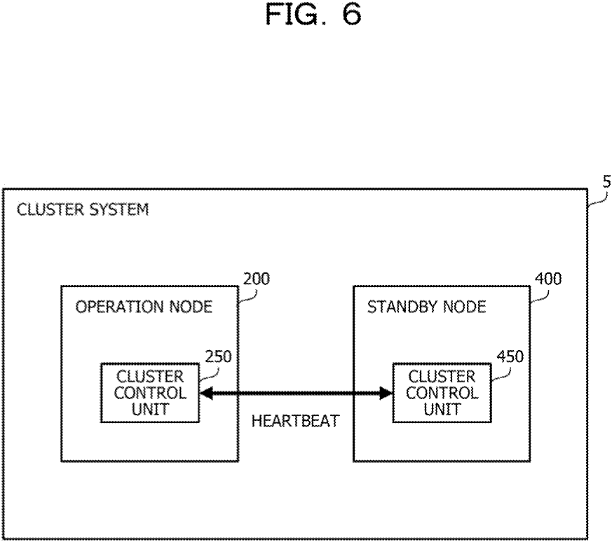

FIG. 6 is a diagram illustrating an example of a heartbeat between an operation node and a standby node.

A cluster system 5 is a subsystem of the information processing system 2. The cluster system 5 includes the operation node 200 and the standby node 400. The standby node 400 includes a cluster control unit 450. The cluster control unit 450 is implemented by a program stored in a RAM of a physical machine that functions as the standby node 400 being executed by a CPU of the physical machine. The cluster control unit 450 cooperates with the cluster control unit 250 to improve an availability of a service provided to the client node 600 by the cluster system 5.

The cluster control unit 250 transmits a heartbeat to the cluster control unit 450. The cluster control unit 450 transmits a heartbeat to the cluster control unit 250. When the heartbeat from the cluster control unit 250 is stopped, the cluster control unit 450 determines that the service provision by the operation node 200 is stopped. By using the NW service 820, the cluster control unit 450 performs a setting for switching an access destination by the client node 600 from the operation node 200 to the standby node 400 on the VPC router 700. Therefore, the service provision is taken over by the standby node 400. The standby node 400 may use the NW service 820 via an API end point provided by an API gateway different from the API gateway 810, provided by the information processing system 2.

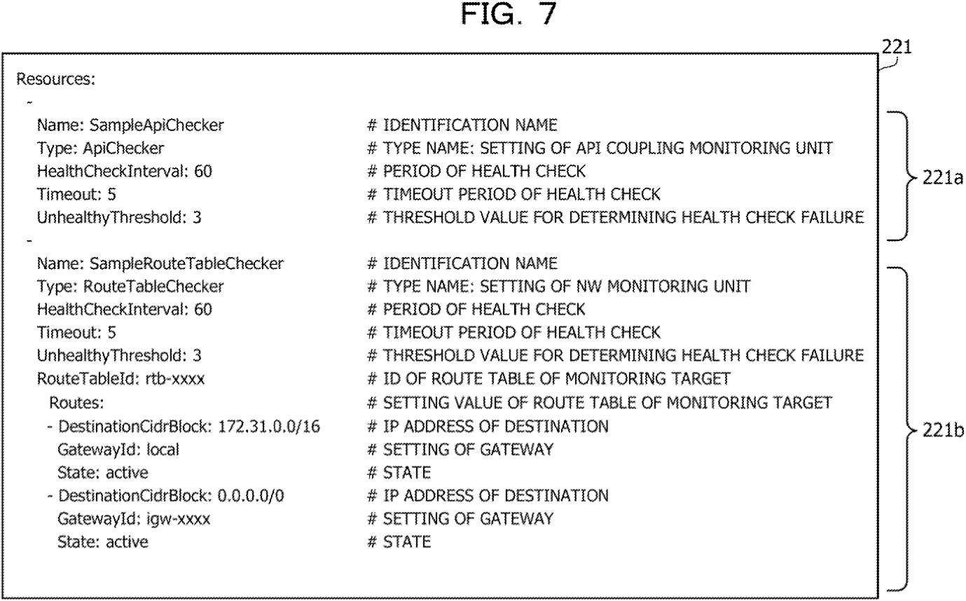

FIG. 7 is a diagram illustrating an example of monitoring setting data.

Monitoring setting data 221 is input to the monitoring setting unit 220 by a user. Based on the monitoring setting data 221, the monitoring setting unit 220 performs settings of the monitoring result processing unit 230 and the serverless function 910. The monitoring setting data 221 includes setting information 221a and 221b.

The setting information 221a is a setting related to the API coupling monitoring unit 911. For example, an item “HealthCheckInterval” indicates an interval (period) of a health check of API coupling by the API coupling monitoring unit 911. The health check of the API coupling is performed by issuing a predetermined command of designating the API end point 811. An item “Timeout” indicates a timeout period of the health check by the API coupling monitoring unit 911. An item “UnhealthyThreshold” is a threshold value with which the monitoring result processing unit 230 determines that the health check fails, for an API monitoring result of the API coupling monitoring unit 911.

As an example of the setting information 221a, HealthCheckInterval = 60 (seconds), Timeout = 5 (seconds), and UnhealthyThreshold = 3 (times) are set for the API coupling monitoring unit 911.

The setting information 221b is a setting related to the NW monitoring unit 912. For example, an item “HealthCheckInterval” indicates an interval of a health check of the VPC router 700 by the NW monitoring unit 912. The health check of the VPC router 700 is performed by acquiring a route table of the VPC router 700. An item “Timeout” indicates a timeout period of the health check by the NW monitoring unit 912. An item “UnhealthyThreshold” is a threshold value with which the monitoring result processing unit 230 determines that the health check fails, for an NW monitoring result of the NW monitoring unit 912. An item “RouteTableId” is an identifier (ID) of a route table of a monitoring target in the VPC router 700. In order for the client node 600 to use the operation node 200, a transfer rule of data to be set in the VPC router 700 is set in an item “Routes”. For example, the transfer rule includes information on a transfer destination according to an internet protocol (IP) address of a destination of the data. Contents of the item “Routes” are notified to the monitoring result processing unit 230 by the monitoring setting unit 220.

As an example of the setting information 221b, HealthCheckInterval = 60 (seconds), Timeout = 5 (seconds), UnhealthyThreshold = 3 (times), and RouteTableId = rtb-xxxx are set for the NW monitoring unit 912. For the route table indicated by the RouteTableId, the transfer rule including a setting or the like in which a gateway of a transfer destination for a destination IP address “172.31.0.0/16” is set to “local” is set.

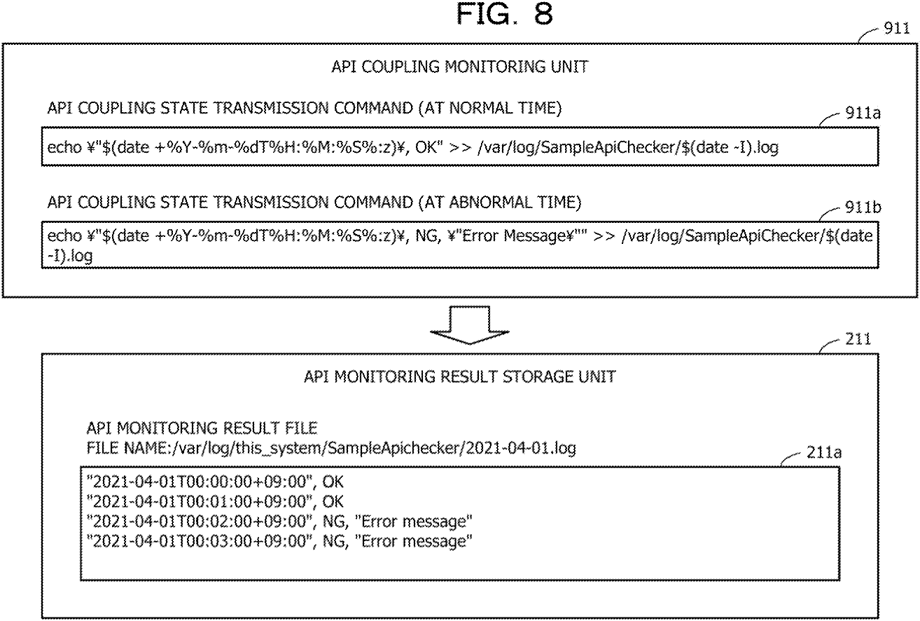

FIG. 8 is a diagram illustrating a generation example of an API monitoring result by the API coupling monitoring unit.

According to a result of checking coupling to the NW service 820 via the API end point 811, the API coupling monitoring unit 911 issues one of API coupling state transmission commands 911a and 911b to the operation node 200. Therefore, the API coupling monitoring unit 911 notifies the operation node 200 of the API monitoring result. The API monitoring result is recorded in an API monitoring result file 211a of the API monitoring result storage unit 211.

The API coupling state transmission command 911a is issued to the operation node 200 in a case where a result of checking coupling to the NW service 820 is normal. For example, the API coupling monitoring unit 911 executes the API coupling state transmission command 911a to the operation node 200 by using secure shell (SSH). Therefore, a record indicating a time when the coupling checking is performed or an execution time of the command and indicating that the result of the coupling checking at the time is normal (OK) is recorded in the API monitoring result file 211a.

The API coupling state transmission command 911b is issued to the operation node 200 in a case where the result of the checking coupling to the NW service 820 is abnormal. For example, the API coupling monitoring unit 911 executes the API coupling state transmission command 911b to the operation node 200 by using SSH. Therefore, a record indicating a time when the coupling checking is performed or an execution time of the command and indicating that the result of the coupling checking at the time is abnormal (NG) is recorded in the API monitoring result file 211a.

When a record indicating NG is continuously recorded a number of times equal to a threshold value indicated by UnhealthyThreshold in the setting information 221a of the monitoring setting data 221, the monitoring result processing unit 230 determines that the API coupling checking by the serverless function 910 is abnormal.

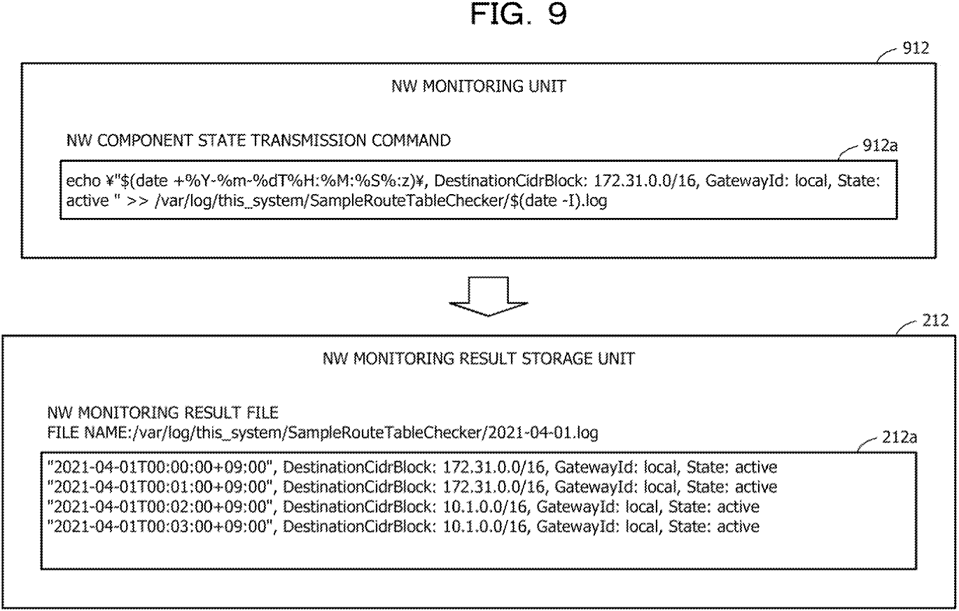

FIG. 9 is a diagram illustrating a generation example of the NW monitoring result by an NW monitoring unit.

According to an acquisition result of a route table of the VPC router 700 by using the NW service 820, the NW monitoring unit 912 issues an NW component state transmission command 912a to the operation node 200. Therefore, the NW monitoring unit 912 notifies the operation node 200 of the NW monitoring result. The NW monitoring result is recorded in an NW monitoring result file 212a of the NW monitoring result storage unit 212.

The NW component state transmission command 912a includes contents of the route table of the VPC router 700 acquired by the NW monitoring unit 912. For example, the NW monitoring unit 912 executes the NW component state transmission command 912a to the operation node 200 by using SSH. Therefore, a record indicating a time when the route table is acquired or an execution time of the command, and the contents of the route table at the time is recorded in the NW monitoring result file 212a.

For example, the monitoring result processing unit 230 may determine whether or not the route table of the VPC router 700 is correct by collating the contents of the normal route table acquired from the monitoring setting unit 220 with the contents of the current route table recorded in the NW monitoring result file 212a.

In a case where the NW monitoring unit 912 may not appropriately acquire the route table of the VPC router 700 via the NW service 820, a record having no content of the route table may be recorded in the NW monitoring result file 212a. For example, in this case, when a record having no content of the route table is continuously recorded the number of times equal to the number of times of the UnhealthyThreshold in the setting information 221b of the monitoring setting data 221, the monitoring result processing unit 230 may determine that the NW checking by the serverless function 910 is abnormal.

A processing procedure to be executed by the information processing system 2 will be described. First, a processing example of the monitoring setting unit 220 in the operation node 200 will be described.

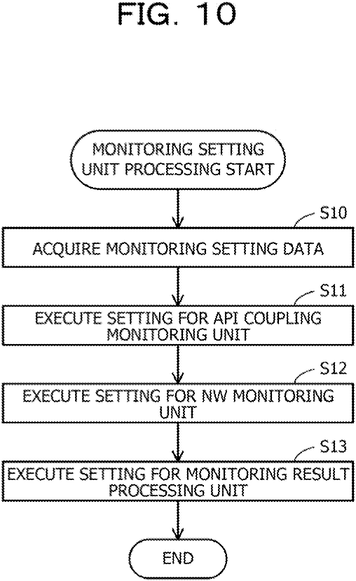

FIG. 10 is a flowchart illustrating a processing example of the monitoring setting unit.

(S10) The monitoring setting unit 220 acquires the monitoring setting data 221. The monitoring setting data 221 is input by a user.

(S11) The monitoring setting unit 220 executes a setting for the API coupling monitoring unit 911 based on the monitoring setting data 221. For example, the monitoring setting unit 220 sets a period (interval of health check) of API coupling monitoring by the API coupling monitoring unit 911, for the event bus service 920. The monitoring setting unit 220 sets a timeout period for the API coupling monitoring unit 911.

(S12) The monitoring setting unit 220 executes a setting for the NW monitoring unit 912 based on the monitoring setting data 221. For example, the monitoring setting unit 220 sets a period (interval of health check) of NW monitoring by the NW monitoring unit 912, for the event bus service 920. The monitoring setting unit 220 sets a timeout period and a route table ID of a monitoring target in the VPC router 700 in the NW monitoring unit 912. By executing steps S11 and S12, the monitoring setting unit 220 instructs the event bus service 920 to execute the serverless function 910.

(S13) The monitoring setting unit 220 executes a setting for the monitoring result processing unit 230, based on the monitoring setting data 221. For example, the monitoring setting unit 220 sets, in the monitoring result processing unit 230, a value of the UnhealthyThreshold for each of the API monitoring result and the NW monitoring result, and contents of a normal route table to be collated with the NW monitoring result. The processing of the monitoring setting unit 220 is ended.

Next, a monitoring processing example using the serverless function 910 will be described.

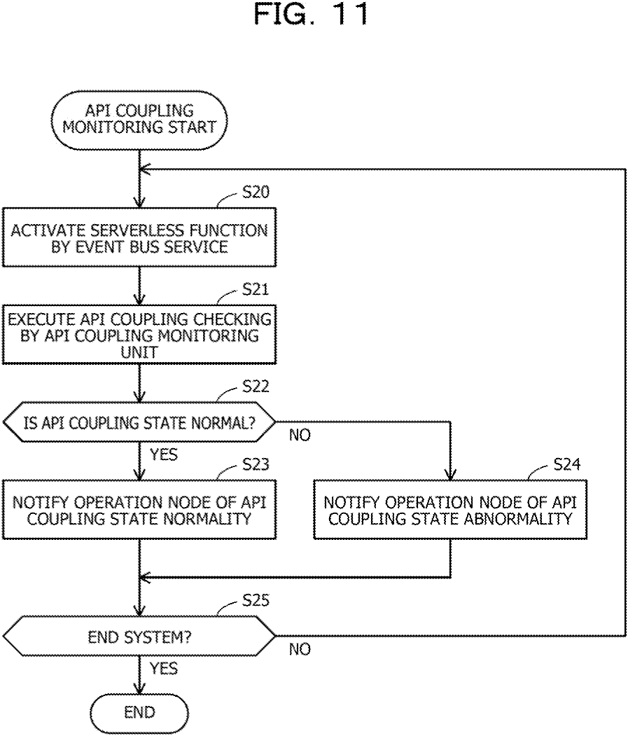

FIG. 11 is a flowchart illustrating an example of API coupling monitoring by a serverless function.

(S20) The event bus service 920 activates the serverless function 910 at a period set for the API coupling monitoring unit 911 by the monitoring setting unit 220. Therefore, the API coupling monitoring unit 911 is activated.

(S21) The API coupling monitoring unit 911 executes API coupling checking. For example, the API coupling monitoring unit 911 issues a predetermined coupling checking command for designating the API end point 811, and checks a coupling availability to the NW service 820 via the API end point 811, based on an execution result of the command. For example, in a case of AWS, DescribeInstances, which is an API of AWS, may be used to issue the command.

(S22) The API coupling monitoring unit 911 determines whether or not an API coupling state is normal. In a case where the API coupling state is normal, the process proceeds to step S23. In a case where the API coupling state is abnormal, the process proceeds to step S24. For example, in a case where the execution result of the predetermined command in step S21 is normal, the API coupling monitoring unit 911 determines that the API coupling state is normal. In a case where the execution result of the predetermined command in step S22 is abnormal, the API coupling monitoring unit 911 determines that the API coupling state is abnormal.

(S23) The API coupling monitoring unit 911 notifies the operation node 200 of the API coupling state normality by issuing the API coupling state transmission command 911a to the operation node 200. For example, the API coupling monitoring unit 911 issues the API coupling state transmission command 911a to the operation node 200 by using SSH. Therefore, a record indicating the API coupling state normality is recorded in the API monitoring result file 211a of the API monitoring result storage unit 211. The operation of the API coupling monitoring unit 911 is ended. The process proceeds to step S25.

(S24) The API coupling monitoring unit 911 notifies the operation node 200 of the API coupling state abnormality by issuing the API coupling state transmission command 911b to the operation node 200. For example, the API coupling monitoring unit 911 issues the API coupling state transmission command 911b to the operation node 200 by using SSH. Therefore, a record indicating the API coupling state abnormality is recorded in the API monitoring result file 211a of the API monitoring result storage unit 211. The operation of the API coupling monitoring unit 911 is ended. The process proceeds to step S25.

(S25) The event bus service 920 determines whether or not the cluster system 5 by the operation node 200 and the standby node 400 is ended. In a case where the cluster system 5 is ended, the event bus service 920 ends the API coupling monitoring. In a case where the cluster system 5 is not ended, the process proceeds to step S20.

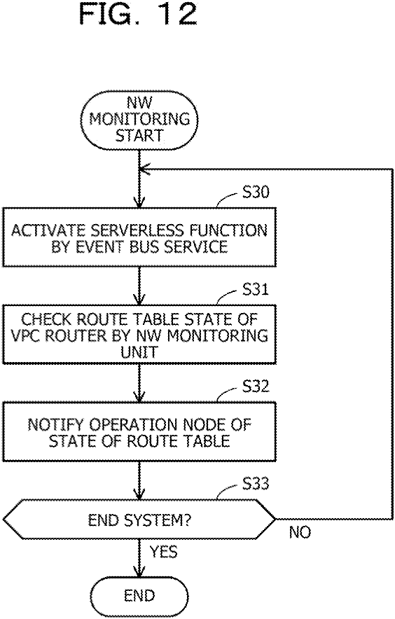

FIG. 12 is a flowchart illustrating an example of NW monitoring by a serverless function.

(S30) The event bus service 920 activates the serverless function 910 at a period set for the NW monitoring unit 912 by the monitoring setting unit 220. Therefore, the NW monitoring unit 912 is activated.

(S31) The NW monitoring unit 912 checks a route table state of the VPC router 700. For example, the NW monitoring unit 912 uses the NW service 820 via the API end point 811 to acquire the route table of the VPC router 700. For example, in a case of AWS, DescribeRouteTables, which is an API of AWS, may be used to acquire the route table.

(S32) The NW monitoring unit 912 notifies the operation node 200 of an NW monitoring result, for example, the acquired state of the route table by issuing the NW component state transmission command 912a to the operation node 200. For example, the NW monitoring unit 912 issues the NW component state transmission command 912a to the operation node 200 by using SSH. Therefore, a record indicating contents of the route table of the VPC router 700 is recorded in the NW monitoring result file 212a of the NW monitoring result storage unit 212. The operation of the NW monitoring unit 912 is ended.

(S33) The event bus service 920 determines whether or not the cluster system 5 by the operation node 200 and the standby node 400 is ended. In a case where the cluster system 5 is ended, the event bus service 920 ends the NW monitoring. In a case where the cluster system 5 is not ended, the process proceeds to step S30.

Next, a processing example of the cluster control unit 250 in the operation node 200 will be described.

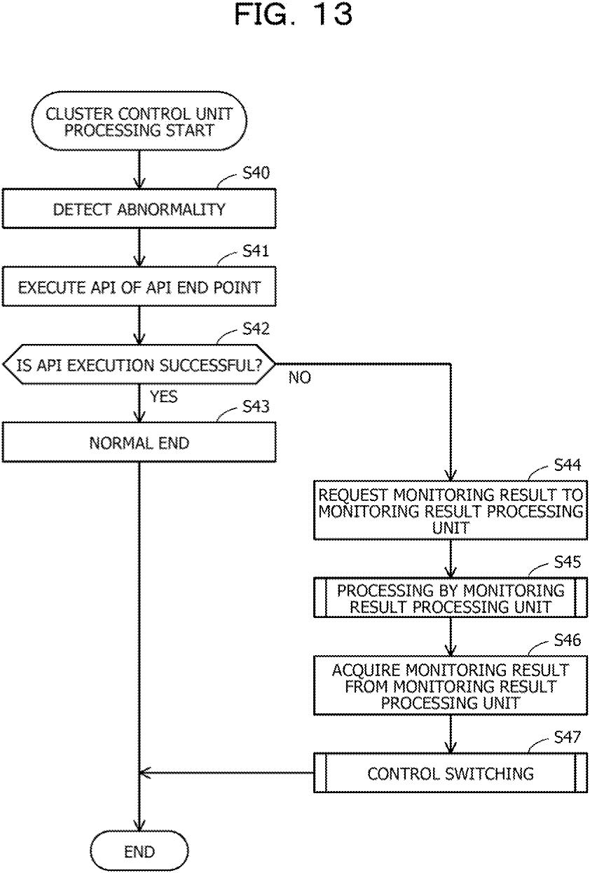

FIG. 13 is a flowchart illustrating a processing example of a cluster control unit.

(S40) The cluster control unit 250 detects an abnormality in the operation node 200. For example, the cluster control unit 250 periodically refers to information such as a route table of the VPC router 700, and detects the abnormality in a case where the reference is not performed.

(S41) The cluster control unit 250 executes an API of the NW service 820 via the API end point 811.

(S42) The cluster control unit 250 determines whether or not the API is successfully executed. In a case where the execution is successful, the process proceeds to step S43. In a case where the execution fails, the process proceeds to step S44.

(S43) Since the API is successfully executed, the cluster control unit 250 determines that switching to the standby node 400 is not desirable, and normally ends the process. Therefore, the processing of the cluster control unit 250 is ended.

(S44) The cluster control unit 250 requests the monitoring result processing unit 230 for a monitoring result of an API coupling state by the serverless function 910.

(S45) The monitoring result processing unit 230 performs processing based on the API monitoring result and the NW monitoring result acquired by the serverless function 910 in response to the request from the cluster control unit 250. Details of the processing by the monitoring result processing unit 230 will be described below.

(S46) The cluster control unit 250 acquires a monitoring result of the API coupling state by the serverless function 910 from the monitoring result processing unit 230.

(S47) The cluster control unit 250 performs switching control related to switching to the standby node 400, based on the monitoring result of the API coupling state acquired from the monitoring result processing unit 230. The processing of the cluster control unit 250 is ended.

By periodically performing steps S41 and S42 without executing step S40, the cluster control unit 250 may monitor whether or not the API coupling may be normally performed.

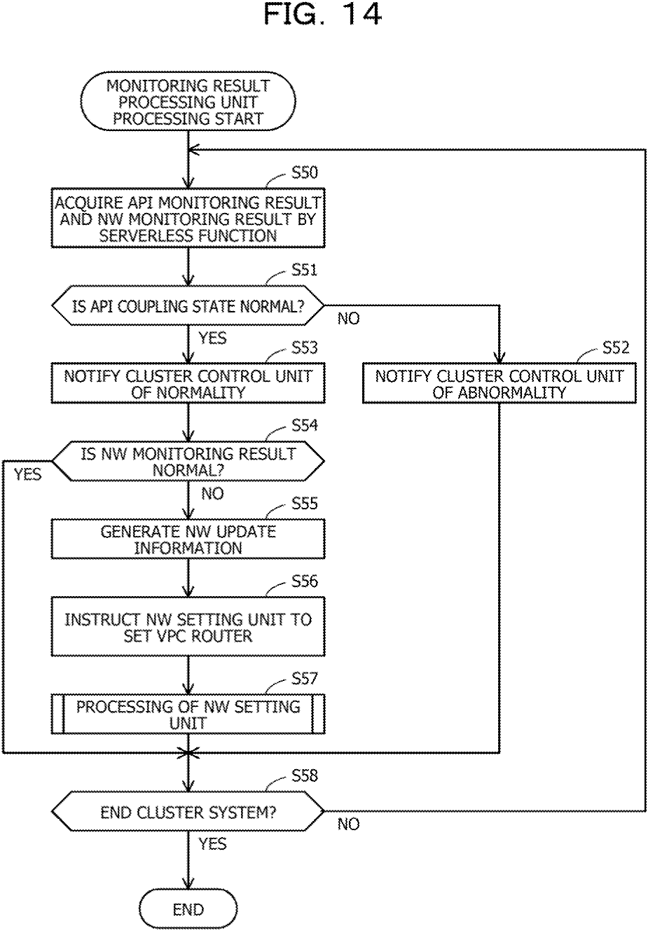

FIG. 14 is a flowchart illustrating a processing example of a monitoring result processing unit.

Processing of the monitoring result processing unit corresponds to step S45.

(S50) The monitoring result processing unit 230 acquires an API monitoring result and an NW monitoring result by the serverless function 910 in response to a request from the cluster control unit 250. For example, the monitoring result processing unit 230 acquires the API monitoring result file 211a stored in the API monitoring result storage unit 211 as the API monitoring result. The monitoring result processing unit 230 acquires the NW monitoring result file 212a stored in the NW monitoring result storage unit 212 as the NW monitoring result.

(S51) The monitoring result processing unit 230 determines whether or not an API coupling state from the serverless function 910 is normal, based on the API monitoring result file 211a. In a case where the API coupling state from the serverless function 910 is normal, the process proceeds to step S53. In a case where the API coupling state from the serverless function 910 is abnormal, the process proceeds to step S52. The case where the API coupling state from the serverless function 910 is normal is a case where the latest record in the API monitoring result file 211a indicates a normality (OK). The case where the API coupling state from the serverless function 910 is abnormal indicates that the latest record in the API monitoring result file 211a indicates an abnormality (NG), and is a case where a record indicating an abnormality is continuously recorded a predetermined number of times backward from the latest record. The predetermined number of times corresponds to a threshold value indicated by UnhealthyThreshold of the setting information 221a in the monitoring setting data 221.

(S52) The monitoring result processing unit 230 notifies the cluster control unit 250 of the abnormality in the monitoring result of the API coupling state by the serverless function 910. The process proceeds to step S58.

(S53) The monitoring result processing unit 230 notifies the cluster control unit 250 of the normality in the monitoring result of the API coupling state by the serverless function 910.

(S54) The monitoring result processing unit 230 determines whether or not the NW monitoring result by the serverless function 910 is normal. In a case where the NW monitoring result is normal, the process proceeds to step S58. In a case where the NW monitoring result is abnormal, the process proceeds to step S55. The case where the NW monitoring result is normal is a case where contents of a route table of the VPC router 700 indicated by the latest record of the NW monitoring result file 212a coincide with contents of a route table included in the setting information 221b of the monitoring setting data 221. In a case where the contents of the route table of the VPC router 700 do not coincide with the contents of the route table included in the setting information 221b of the monitoring setting data 221, the NW monitoring result is abnormal.

(S55) The monitoring result processing unit 230 generates NW update information indicating the contents of the normal route table of the VPC router 700.

(S56) The monitoring result processing unit 230 notifies the NW setting unit 240 of the generated NW update information, and instructs the NW setting unit 240 to set the VPC router 700 based on the NW update information.

(S57) The NW setting unit 240 sets the route table of the VPC router 700, according to the instruction from the monitoring result processing unit 230. Details of the processing of the NW setting unit 240 will be described below.

(S58) The monitoring result processing unit 230 determines whether or not the cluster system 5 by the operation node 200 and the standby node 400 is ended. In a case where the cluster system 5 is ended, the monitoring result processing unit 230 ends the processing. In a case where the cluster system 5 is not ended, the monitoring result processing unit 230 advances the processing to step S50, and waits for a request from the cluster control unit 250.

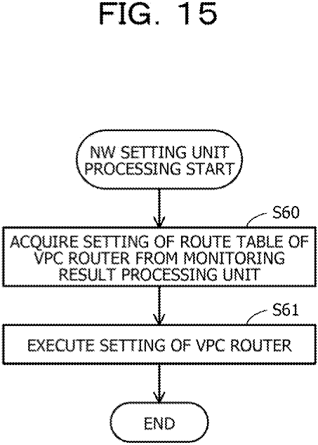

FIG. 15 is a flowchart illustrating a processing example of an NW setting unit.

Processing of the NW setting unit 240 corresponds to step S57.

(S60) The NW setting unit 240 acquires a setting of a normal route table of the VPC router 700 from the monitoring result processing unit 230.

(S61) The NW setting unit 240 sets the acquired route table in the VPC router 700. For example, the NW setting unit 240 uses the NW service 820 via the API end point 811 to set a normal route table for the VPC router 700. The processing of the NW setting unit 240 is ended.

At a stage at which a coupling property between the operation node 200 and the API end point 811 is restored, the NW setting unit 240 may set the VPC router 700.

For example, in a case of AWS, in step S61, the NW setting unit 240 executes the following command, so that a normal setting of the route table for the VPC router 700 is performed.

RTB_ID = $(aws ec2 create-route-table--vpc-id vpc-xxxx--query
RouteTable.RouteTableId--output text)
aws ec2 create-route--route-table-id ${RTB_ID}--destination-cidr-
block 172.31.0.0/16--gateway-id local
aws ec2 create-route--route-table-id ${RTB_ID}--destination-cidr-
block 0.0.0.0/0--gateway-id igw-xxxx

For example, a value of “RouteTableId” in the setting information 221b of the monitoring setting data 221 is used for a route table ID indicating a route table to be set in the command described above.

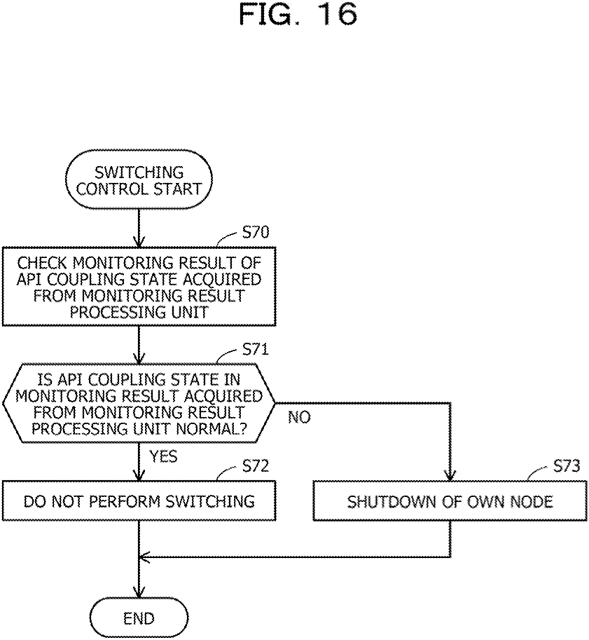

FIG. 16 is a flowchart illustrating an example of switching control by the cluster control unit.

The switching control by the cluster control unit 250 corresponds to step S47.

(S70) The cluster control unit 250 checks a monitoring result of an API coupling state by the serverless function 910, which is acquired from the monitoring result processing unit 230.

(S71) The cluster control unit 250 determines whether or not the API coupling state is normal in the monitoring result acquired from the monitoring result processing unit 230. In a case where the API coupling state is normal, the process proceeds to step S72. In a case where the API coupling state is abnormal, the process proceeds to step S73.

(S72) The cluster control unit 250 determines not to perform switching to the standby node 400, and ends the switching control.

(S73) The cluster control unit 250 determines to perform switching to the standby node 400, and shuts down the own node, for example, the operation node 200. With the shutdown of the operation node 200, a heartbeat from the operation node 200 to the standby node 400 is stopped.

Next, a processing example of the cluster control unit 450 in the standby node 400 will be described.

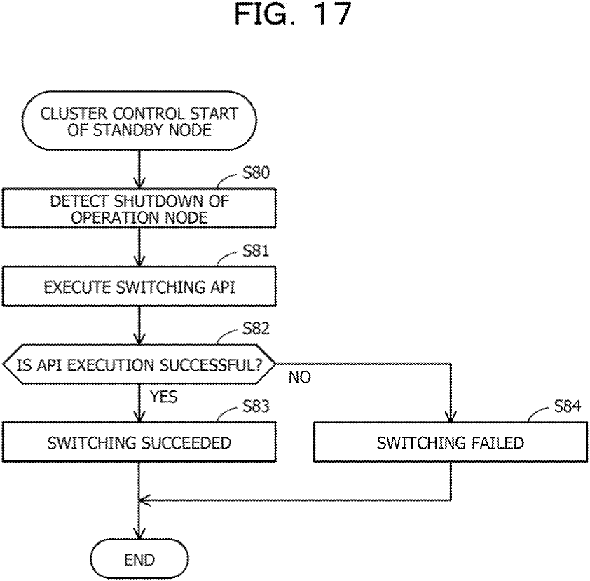

FIG. 17 is a flowchart illustrating a processing example of a cluster control unit of a standby node.

(S80) The cluster control unit 450 detects a shutdown of the operation node 200 by stopping a heartbeat from the operation node 200.

(S81) The cluster control unit 450 executes the switching API in order to switch an access destination of the client node 600 from the operation node 200 to the standby node 400. For example, the cluster control unit 450 may use the NW service 820 by executing an API via an API end point provided by an API gateway different from the API gateway 810, and may set the switching for the VPC router 700.

(S82) The cluster control unit 450 determines whether or not the API is successfully executed in step S81. In a case where the API execution is successful, the process proceeds to step S83. In a case where the API execution fails, the process proceeds to step S84.

(S83) The cluster control unit 450 determines that the switching is successful, and normally ends the processing.

(S84) The cluster control unit 450 determines that the switching fails, executes predetermined abnormal time processing, and ends the processing.

As described above, the operation node 200 determines whether or not to perform switching to the standby node 400, based on the result of the API coupling checking by the serverless function 910. The serverless function 910 is executed by a serverless function execution machine belonging to a higher-level network of the information processing system 2. Accordingly, in the API coupling checking via the API end point 811, the serverless function 910 is less likely to be affected by a network in the coupling to the API end point 811 than the operation node 200. Therefore, by using the result of the API coupling checking by the serverless function 910, the operation node 200 may appropriately determine whether or not an access abnormality to information of the VPC router 700 detected by the operation node 200 is caused by the network coupling property between the operation node 200 and the API gateway 810. An example of the problem in the network between the operation node 200 and the API gateway 810 is a case where communication in the network is temporarily delayed due to a temporary increase in load or the like.

In a case where the API coupling result of the serverless function 910 is normal, the access abnormality to the information of the VPC router 700 detected by the operation node 200 is caused by a problem of the network coupling property. In this case, there is a high possibility that the problem of the network is restored in a short time by the information processing system 2. For example, the information processing system 2 may quickly handle the increase in load of the network, with scale-out of network resources. Alternatively, the temporary increase in load on the network may be spontaneously restored with a decrease in load. Therefore, the operation node 200 determines that switching to the standby node 400 is undesirable, and does not perform the switching to the standby node 400. Therefore, the operation node 200 may suppress undesirable switching to the standby node 400.

By contrast, in a case where the API coupling result of the serverless function 910 is abnormal, the access abnormality detected by the operation node 200 includes another factor such as an operation abnormality of the API gateway 810, and the access abnormality is unlikely to be restored in a short time. Accordingly, in this case, the operation node 200 performs switching to the standby node 400. Therefore, the operation node 200 may appropriately detect the abnormality, and perform the switching to the standby node 400.

As a method of monitoring the VPC router 700 by the operation node 200, it is also conceivable that the operation node 200 performs monitoring depending on whether API coupling from the operation node 200 to the NW service 820 is timed out. For example, in a case where an execution waiting time of the API periodically executed exceeds a predetermined timeout value, the operation node 200 determines that the VPC router 700 is not abnormal, and suppresses the switching. Meanwhile, since this method waits until the execution waiting time exceeds the timeout value, it takes time from a time point when the coupling abnormality actually occurs to a detection of the coupling abnormality of the API. In a case where the coupling abnormality from the operation node 200 to the corresponding API and the abnormality of the VPC router 700 simultaneously occur, the latter may not be detected.

As a method of making the monitoring related to the VPC router 700 redundant, it is also conceivable to provide a monitoring node for monitoring the VPC router 700 in the subnet 2d1 separately from the operation node 200, instead of the serverless function 910. Meanwhile, when the monitoring node is separately provided, an operation cost for the monitoring node is generated. Since the monitoring node is provided in the subnet 2d1, a problem in the same manner as the operation node 200 may occur in the coupling property of the network between the monitoring node and the API end point 811. By contrast, the serverless function 910 has an advantage of a lower operation cost than a case where the monitoring node is newly provided. Since the serverless function 910 is executed in a relatively higher-level network in the information processing system 2, there is an advantage that a problem of a coupling property to the API end point 811 is unlikely to occur, as compared with the monitoring node.

Based on the route table of the VPC router 700 acquired by the serverless function 910, the operation node 200 may check whether or not there is an abnormality in the route table. In a case where there is the abnormality in the route table, the operation node 200 sets a normal route table in the VPC router 700. Therefore, the operation node 200 may suppress switching to the standby node 400 with the abnormality in the route table of the VPC router 700. The operation node 200 may further improve an availability of the cluster system 5.

With the determination in step S54 in FIG. 14, the monitoring result processing unit 230 may use the threshold value set in “UnhealthyThreshold” in the setting information 221b of the monitoring setting data 221. For example, the monitoring result processing unit 230 may determine that NW checking by the serverless function 910 is abnormal and there is an abnormality in the operation of the VPC router 700 when a record having no content of the route table is continuously recorded the number of times equal to the threshold value by tracing back from the latest record. In this case, for example, the monitoring result processing unit 230 may instruct the cluster control unit 250 to perform switching into the standby node 400. According to the instruction, the cluster control unit 250 may perform the switching to the standby node 400 by stopping the heartbeat with a shutdown of the own node. Therefore, the operation node 200 may appropriately detect the abnormality of the VPC router 700, and perform the switching to the standby node 400.

In step S61 in FIG. 15, the NW setting unit 240 may fail to normally set the route table for the VPC router 700. Accordingly, in a case where the normal setting of the route table for the VPC router 700 fails, the NW setting unit 240 may notify the monitoring result processing unit 230 of the setting failure. In this case, the monitoring result processing unit 230 may instruct the cluster control unit 250 to perform switching to the standby node 400, in response to the notification of the setting failure. According to the instruction, the cluster control unit 250 may perform the switching to the standby node 400 by stopping the heartbeat with a shutdown of the own node. Therefore, the operation node 200 may appropriately detect the abnormality of the VPC router 700, and perform the switching to the standby node 400.

As described above, the information processing system 2 performs, for example, the following processing.

The operation node 200 acquires first information that is an output of the serverless function 910 and indicates a result of coupling checking by the serverless function 910 for a first service used for monitoring a network node by the operation node 200. Based on the first information, the operation node 200 controls whether or not to switch the node of the access destination by the client node 600 via the network node from the operation node 200 to the standby node 400.

Therefore, the operation node 200 may suppress undesirable switching. The VPC router 700 is an example of a network node. The API monitoring result file 211a or the record recorded in the API monitoring result file 211a is an example of the first information. The NW service 820 is an example of the first service.

For example, the operation node 200 does not perform the switching in a case where the result of the coupling checking by the serverless function 910 indicated by the first information is normal, under control of the switching from the operation node 200 to the standby node 400. By contrast, in a case where the result of the coupling checking indicated by the first information is abnormal, the operation node 200 performs the switching.

Therefore, the operation node 200 may suppress undesirable switching. The operation node 200 may appropriately specify an event to be switched.

In a case where the result of the coupling checking indicated by the first information is normal, the operation node 200 acquires second information indicating setting contents of the network node acquired by using the first service by the serverless function 910. Based on the third information indicating the normal setting contents of the network node input by the user from the terminal apparatus 4 and the second information, the operation node 200 determines whether or not the second information is normal. In a case where the second information is not normal, the operation node 200 sets third information in the network node by using the first service.

Therefore, the operation node 200 may automatically repair the abnormality of the setting content of the network node, for example, the VPC router 700, and improve the availability of the cluster system 5 formed by the operation node 200 and the standby node 400. The NW monitoring result file 212a or the record recorded in the NW monitoring result file 212a is an example of the second information. Contents of the item “Routes” included in the setting information 221b of the monitoring setting data 221 are examples of the third information.

For example, the third information is routing information including a transfer rule of data from the client node 600 to the operation node 200. Therefore, the operation node 200 may automatically repair the access abnormality caused by the VPC router 700 from the client node 600 to the operation node 200. The operation node 200 does not have to perform switching to the standby node 400, in response to the access abnormality caused by the VPC router 700 from the client node 600 to the operation node 200.

In a case where the result of the coupling checking indicated by the first information is normal and the operation node 200 may not acquire the setting contents of the network node, for example, the VPC router 700, the operation node 200 may detect an abnormality of the network node and perform switching to the standby node 400. In a case where the result of the coupling checking indicated by the first information is normal and the setting of the third information to the network node, for example, the VPC router 700 fails, the operation node 200 may detect an abnormality of the network node and perform switching to the standby node 400.

The operation node 200 instructs the information processing system 2 to periodically execute the serverless function 910. When the abnormality is detected by monitoring a network node in the operation node 200, for example, the VPC router 700, the operation node 200 may control the switching from the operation node 200 to the standby node 400, based on the first information. Therefore, the operation node 200 may suppress undesirable switching, with the abnormality detection based on monitoring of the operation node 200 itself.

The serverless function 910 may perform coupling checking on the first service, based on success or failure of execution of the API via an API end point corresponding to the first service. Therefore, the serverless function 910 may easily check the coupling to the first service. The NW service 820 is an example of the first service. The API end point 811 is an example of the API end point corresponding to the first service.

For example, the serverless function execution machine 900 executes the serverless function 910 for checking coupling to the first service used for monitoring the network node by the operation node 200 to acquire the first information indicating a result of checking coupling to the first service. The serverless function execution machine 900 stores the first information in the storage unit 210 which is accessible from the operation node 200.

Therefore, the serverless function execution machine 900 may support suppression of undesirable switching by the operation node 200. The serverless function execution machine 900 is an example of the execution node 40 according to the first embodiment.

By executing the serverless function 910, the serverless function execution machine 900 may acquire the second information indicating the setting contents of the network node by using the first service, and may store the second information in the storage unit 210. Therefore, the serverless function execution machine 900 may support checking by the operation node 200 whether or not the setting contents of the network node are normal.

The information processing method of the information processing system 2 may be described as follows.

The serverless function execution machine 900 executes the serverless function for checking coupling to the first service used for monitoring the network node by the operation node 200 to acquire the first information indicating a result of checking coupling to the first service. The serverless function execution machine 900 stores the first information in the storage unit 210 which is accessible from the operation node 200. Based on the first information stored in the storage unit 210, the operation node 200 controls whether or not to switch the node of the access destination by the client node 600 via the network node from the operation node 200 to the standby node 400.

Therefore, the information processing system 2 may suppress undesirable switching. The serverless function execution machine 900 is an example of the execution node 40 according to the first embodiment.

The information processing according to the first embodiment may be achieved by causing the processing unit 12 to execute a program. The information processing of the second embodiment may be implemented by causing the CPU 101 to execute a program. The program may be recorded in the computer-readable recording medium 113.

For example, the program may be circulated by distributing the recording medium 113 in which the program is recorded. The programs may be stored in another computer and the programs may be distributed via a network. For example, the computer may store (install), in a storage device such as the RAM 102 or the HDD 103, the program recorded in the recording medium 113 or the program received from the another computer, and may read the program from the storage device to execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer that operates as an operation node in an information processing system which includes the operation node, a standby node corresponding to the operation node, and a network node which relays communication from a client node to the operation node or the standby node, to execute a process comprising:
acquiring first information that is an output of a serverless function executed by the information processing system and indicates a result of coupling checking by the serverless function for a first service used for monitoring of the network node by the operation node; and
controlling whether or not to switch a node of an access destination by the client node via the network node from the operation node to the standby node, based on the first information.

2. The non-transitory computer-readable recording medium according to claim 1,
wherein the program causes the computer to execute a process of
in control of switching from the operation node to the standby node,
not performing the switching, in a case where the result of the coupling checking indicated by the first information is normal, and
performing the switching, in a case where the result of the coupling checking indicated by the first information is abnormal.

3. The non-transitory computer-readable recording medium according to claim 1,
wherein the program causes the computer to execute a process of
acquiring second information which indicates setting contents of the network node acquired by using the first service with the serverless function, in a case where the result of the coupling checking indicated by the first information is normal,
determining whether or not the second information is normal, based on third information which indicates normal setting contents of the network node input from a terminal apparatus by a user and the second information, and
setting the third information in the network node by using the first service, in a case where the second information is not normal.

4. The non-transitory computer-readable recording medium according to claim 3,
wherein the third information is routing information which includes a transfer rule of data from the client node to the operation node.

5. The non-transitory computer-readable recording medium according to claim 1,
wherein the program causes the computer to execute a process of
instructing the information processing system to periodically execute the serverless function, and
controlling switching from the operation node to the standby node, based on the first information, when an abnormality is detected in monitoring of the network node by the operation node.

6. The non-transitory computer-readable recording medium according to claim 1,
wherein the serverless function performs the coupling checking on the first service, based on success or failure of execution of an application programming interface (API) via an API end point corresponding to the first service.

7. A non-transitory computer-readable recording medium storing a program for causing a computer used for an information processing system which includes an operation node, a standby node corresponding to the operation node, and a network node which relays communication from a client node to the operation node or the standby node, to execute a process comprising:
acquiring first information which indicates a result of checking coupling to a first service used for monitoring of the network node by the operation node by executing a serverless function for performing the coupling checking on the first service; and
storing the first information in a storage accessible from the operation node.

8. The non-transitory computer-readable recording medium according to claim 7,
wherein the program causes the computer to execute a process of
acquiring second information which indicates setting contents of the network node by using the first service, by executing the serverless function, and storing the second information in the storage.

9. An information processing method comprising:
acquiring, by an operation node in an information processing system which includes the operation node, a standby node corresponding to the operation node, and a network node which relays communication from a client node to the operation node or the standby node, first information that is an output of a serverless function executed by the information processing system and indicates a result of coupling checking by the serverless function for a first service used for monitoring of the network node by the operation node; and
controlling whether or not to switch a node of an access destination by the client node via the network node from the operation node to the standby node, based on the first information.
